(19) United States
(12) Patent Application Publication
(10) Pub. No.: US 2020/0118135 A1
(43) Pub. Date: Apr. 16, 2020

(54) SYSTEMS AND METHODS FOR MONITORING MACHINE LEARNING SYSTEMS

(71) Applicant: MASTERCARD INTERNATIONAL INCORPORATED, Purchase, NY (US)

(72) Inventors: Xianzhe Zhou, Town and Country, MO (US); Xiaoying Zhang, O'Fallon, MO (US); Walter F. Lo Faro, St. Louis, MO (US); Ravi Santosh Arvapally, St. Louis, MO (US)

(21) Appl. No.: 16/653,089

(22) Filed: Oct. 15, 2019

Related U.S. Application Data
(60) Provisional application No. 62/746,348, filed on Oct. 16, 2018.

(51) Int. Cl. G06Q 20/40; G06N 20/00; G06F 16/901

(52) U.S. Cl. CPC G06Q 20/4016; G06F 16/901; G06N 20/00

(57) ABSTRACT

Systems and methods are provided for use in performing data quality checks on input variables to machine learning systems. One exemplary method includes calculating a first moment associated with a long term variable (LTV), based on the value of the LTV and historical values of the LTV over a defined interval; and calculating a second moment associated with the LTV, based on the value of the LTV and the historical values of the LTV over the defined interval. The first moment and the second moment provide a moment pair. An isolation forest analysis is performed based on the moment pairs. And, a flag is generated for the LTV, when a check value of the LTV is different than the value of the LTV, and/or when the isolation forest analysis indicates the calculated moment pair is an anomaly.

### CROSS-REFERENCE TO RELATED APPLICATION

This application claims the benefit of, and priority to, U.S. Provisional Application No. 62/746,348 filed on Oct. 16, 2018. The entire disclosure of the above-referenced application is incorporated herein by reference.

### FIELD

The present disclosure generally relates to systems and methods for use in monitoring machine learning systems and, in particular, for performing data quality checks on input variables to the machine learning systems provided through and/or stored in computer networks (e.g., in data structures associated with the computer networks, etc.).

### BACKGROUND

This section provides background information related to the present disclosure which is not necessarily prior art.

Machine learning (ML) systems are a subset of artificial intelligence (AI). In connection therewith, ML systems are known to generate models and/or rules, based on sample data provided as input to the ML systems.

Separately, consumers typically use payment accounts in transactions to fund purchases of products (e.g., good and services, etc.) from merchants. Transaction data, representative of such transactions, is known to be collected and stored in one or more data structures as evidence of the transactions. The transaction data may be stored, for example, by payment networks, issuers, merchants, and/or acquirers involved in the transactions. Subsequently, it is known for the payment networks, for example, to use the transaction data as input to ML systems to develop fraud prevention models, as well as for merchants to use the transaction data to coordinate targeted advertising and/or offers to customers.

### DRAWINGS

The drawings described herein are for illustrative purposes only of selected embodiments and not all possible implementations, and are not intended to limit the scope of the present disclosure.

FIG. 1 illustrates an exemplary system of the present disclosure suitable for use in monitoring machine learning systems and, in particular, for performing data quality checks on input variables to the machine learning systems provided through and/or stored in computer networks, where the input variables are appended to the data structures at one or more intervals;

FIG. 2 is a block diagram of a computing device that may be used in the exemplary system of FIG. 1;

FIG. 3 is an exemplary method that may be implemented in connection with the system of FIG. 1 for monitoring machine learning systems and, in particular, for performing data quality checks on input variables to the machine learning systems provided through and/or stored in computer networks;

FIGS. 4A-4B are graphical representations of time series data for first and second moments generated in accordance with the system of FIG. 1 and/or the method of FIG. 3 for a given long term variable (LTV); and

FIGS. 5A-5B are graphical representations of week-over-week (WOW) percentage changes for moments generated in accordance with the system of FIG. 1 and/or the method of FIG. 3 for a given LTV.

Corresponding reference numerals indicate corresponding parts throughout the several views of the drawings.

### DETAILED DESCRIPTION

Exemplary embodiments will now be described more fully with reference to the accompanying drawings. The description and specific examples included herein are intended for purposes of illustration only and are not intended to limit the scope of the present disclosure.

Transaction data is often used by acquirers, payment networks, issuers, and/or others to manage and complete purchase transactions, and as an input for establishing insights into, characteristics of, or predictors for consumer behaviors (e.g., for fraud protection, etc.). The transaction data may be used as raw data or as aggregates of the data. One variable associated with such data includes a long term variable (LTV), which is maintained over various intervals and which is updated periodically (e.g., weekly, etc.). An example LTV includes a running total of amount spent for a specific account. In connection therewith, when the transaction data, and derivatives of the data, such as the LTV, is/are incorrect (e.g., due to errors in loading the data, or generating aggregates thereof; etc.), and is/are input to machine learning systems that generate fraud models based on the input, for example, the results/outputs of services relying on the same will generally be incorrect. Verification of the data input to the machine learning systems is therefore required, but not convenient, as it often requires manual intervention.

Uniquely, the systems and methods herein provide processes for verifying variables (e.g., input variables to machine learning systems (e.g., LTVs, etc.), etc.) based on transaction data. In particular, for example, a data quality check engine is provided to access a latest value of an LTV along with underlying data for the value, historical values of the LTV, and historical representations of the distributions of the LTV over time. The engine performs an LTV value check for each of the values, a source data check, and a conformance check (i.e., based on the historical representations of the distributions of the LTV over time, etc.). When any of the checks shows a mismatch, error or anomaly, the engine generates a flag indicative of a need for manual review of the LTV, the payment account(s) associated with the LTV, and/or processing associated with the LTV. In this manner, quality checks of the LTV are performed in an efficient manner, which is specific to the LTV, so that processes relying on the values of the LTV (e.g., machine learning systems generating fraud models based on the LTV, etc.) are permitted to perform accurately.

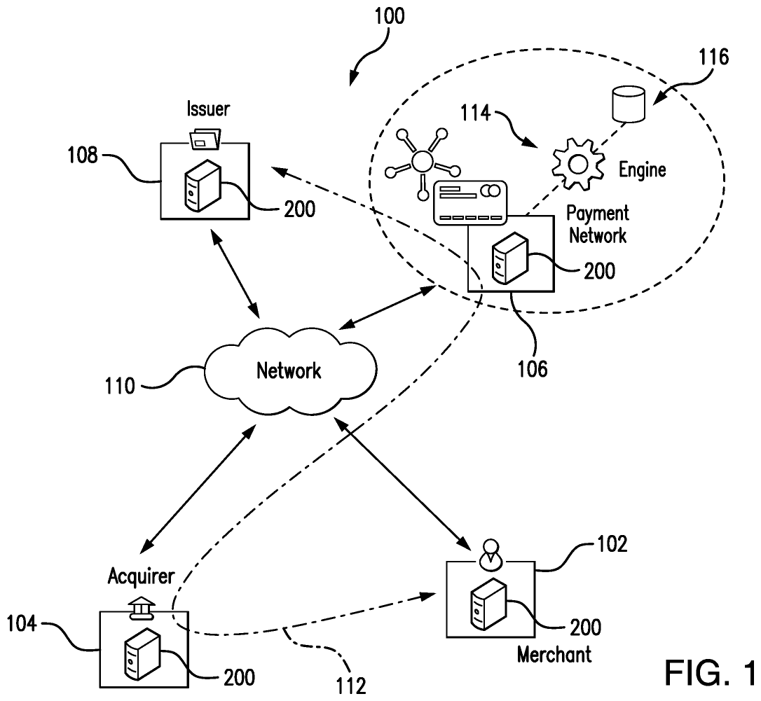

FIG. 1 illustrates an exemplary system 100, in which one or more aspects of the present disclosure may be implemented. Although the system 100 is presented in one arrangement, other embodiments may include systems arranged otherwise depending, for example, on types of transaction data in the systems, types of LTVs associated with the transaction data, privacy requirements, etc.

As shown in FIG. 1, the system 100 generally includes a merchant 102, an acquirer 104, a payment network 106, and an issuer 108, each coupled to (and in communication with) network 110. The network 110 may include, without limitation, a local area network (LAN), a wide area network (WAN) (e.g., the Internet, etc.), a mobile network, a virtual network, and/or another suitable public and/or private network capable of supporting communication among two or more of the parts illustrated in FIG. 1, or any combination thereof. For example, network 110 may include multiple different networks, such as a private payment transaction network made accessible by the payment network 106 to the acquirer 104 and the issuer 108 and, separately, the public Internet, which may be accessible as desired to the merchant 102, the acquirer 104, etc.

The merchant 102 is generally associated with products (e.g., goods and/or services, etc.) for purchase by one or more consumers, for example, via payment accounts. The merchant 102 may include an online merchant, having a virtual location on the Internet (e.g., a website accessible through the network 110, etc.), or a virtual location provided through a web-based application, etc., that permits consumers to initiate transactions for products offered for sale by the merchant 102. In addition, or alternatively, the merchant 102 may include at least one brick-and-mortar location.

In connection with a purchase of a product by a consumer (not shown) at the merchant 102, via a payment account associated with the consumer, for example, an authorization request is generated at the merchant 102 and transmitted to the acquirer 104, consistent with path 112 in FIG. 1. The acquirer 104, in turn, as further indicated by path 112, communicates the authorization request to the issuer 108, through the payment network 106, such as, for example, through Mastercard®, VISA®, Discover®, American Express®, etc. (all, broadly payment networks), to determine (in conjunction with the issuer 108 that provided the payment account to the consumer) whether the payment account is in good standing and whether there is sufficient credit/funds to complete the transaction. If the issuer 108 accepts the transaction, a reply authorizing the transaction (e.g., an authorization reply, etc.) is conventionally provided back to the acquirer 104 and the merchant 102, thereby permitting the merchant 102 to complete the transaction. The transaction is later cleared and/or settled by and between the merchant 102 and the acquirer 104 (via an agreement between the merchant 102 and the acquirer 104), and by and between the acquirer 104 and the issuer 108 (via an agreement between the acquirer 104 and the issuer 108), through further communications therebetween. If the issuer 108 declines the transaction for any reasons, a reply declining the transaction is instead provided back to the merchant 102, thereby permitting the merchant 102 to stop the transaction.

Similar transactions are generally repeated in the system 100, in one form or another, multiple times (e.g., hundreds, thousands, hundreds of thousands, millions, etc. of times) per day (e.g., depending on the particular payment network and/or payment account involved, etc.), and with the transactions involving numerous consumers, merchants, acquirers and issuers. In connection with the above example transaction (and such similar transactions), transaction data is generated, collected, and stored as part of the above exemplary interactions among the merchant 102, the acquirer 104, the payment network 106, the issuer 108, and the consumer. The transaction data represents at least a plurality of transactions, for example, authorized transactions, cleared transactions, attempted transactions, etc. The transaction data, in this exemplary embodiment, is stored at least by the payment network 106 (e.g., in data structure 116, in other data structures associated with the payment network 106, etc.). The transaction data includes, for example (and without limitation), payment instrument identifiers such as payment account numbers, amounts of the transactions, merchant IDs, merchant category codes (MCCs), dates/times of the transactions, products purchased and related descriptions or identifiers, etc. It should be appreciated that more or less information related to transactions, as part of either authorization, clearing, and/or settling, may be included in transaction data and stored within the system 100, at the merchant 102, the acquirer 104, the payment network 106, and/or the issuer 108.

Also in the illustrated system 100, the payment network 106 and/or the issuer 108 are generally configured to compile the transaction data into one or more transaction data aggregates. An example of a transaction data aggregate is a long term variable (LTV). The value of an LTV may, for example, be specific to a given payment account (e.g., associated with a particular primary account number (PAN) for the given payment account, etc.) or general to a payment account segment (or family, for example, of payment accounts (e.g., associated with a particular BIN or card type (e.g., silver payment accounts, etc.), etc.)). An example of an LTV is a lifetime spend to a payment account (or, alternatively, a payment account segment). Here, the LTV represents an aggregate of transactions to a given payment account (or segment of payment accounts) (e.g., the total monetary amount of the transactions to the given payment account or segment of payment accounts, etc.), which is adjusted over time as additional transactions to the payment account (or segment of payment accounts) are authorized, cleared, and/or settled.

Other examples of LTVs include, without limitation, annualized spend, transaction count (with or without time decay), bookstore transaction velocity with a half-life of 180 days, bookstore transaction velocity with a half-life of 360 days, consumer electronics transaction velocity with a half-life of 180 days, consumer electronics transaction velocity with a half-life of 360 days, computer-store transaction velocity with a half-life of 180 days, computer-store transaction velocity with a half-life of 360 days, department store transaction velocity with a half-life of 180 days, department store transaction velocity with a half-life of 360 days, eating place transaction velocity with a half-life of 180 days, eating place transaction velocity with a half-life of 360 days, grocery store transaction velocity with a half-life of 180 days, grocery store transaction velocity with a half-life of 360 days, etc. While the specific examples included herein relate to LTVs, it should be appreciated that any variable, whether long term, short term, having (or not having) a half-life, specific to a payment account (or not), or otherwise, may be subjected to the disclosure herein. What's more, other examples may relate to other categories of spending, etc.

While one merchant 102, one acquirer 104, one payment network 106, and one issuer 108 are illustrated in the system 100 in FIG. 1, it should be appreciated that any number of these entities (and their associated components) may be included in the system 100, or may be included as a part of systems in other embodiments, consistent with the present disclosure.

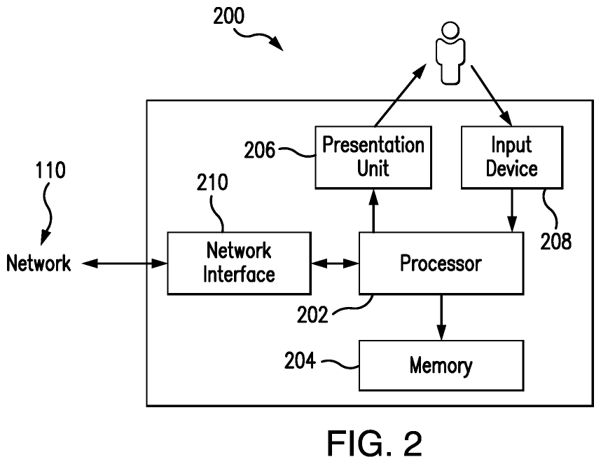

FIG. 2 illustrates an exemplary computing device 200 that can be used in the system 100. The computing device 200 may include, for example, one or more servers, workstations, personal computers, laptops, tablets, smartphones, PDAs, etc. In addition, the computing device 200 may include a single computing device, or it may include multiple computing devices located in close proximity or distributed over a geographic region, so long as the computing devices are specifically configured to function as described herein. However, the system 100 should not be considered to be limited to the computing device 200, as described below, as different computing devices and/or arrangements of computing devices may be used. In addition, different components and/or arrangements of components may be used in other computing devices.

In the exemplary embodiment of FIG. 1, each of the merchant 102, the acquirer 104, the payment network 106, and the issuer 108 are illustrated as including, or being implemented in or associated with, a computing device 200, coupled to the network 110. Further, the computing device 200 associated with each of these parts of the system 100, for example, may include a single computing device, or multiple computing devices located in close proximity or distributed over a geographic region, again so long as the computing devices are specifically configured to function as described herein.

Referring to FIG. 2, the exemplary computing device 200 includes a processor 202 and a memory 204 coupled to (and in communication with) the processor 202. The processor 202 may include one or more processing units (e.g., in a multi-core configuration, etc.) such as, and without limitation, a central processing unit (CPU), a microcontroller, a reduced instruction set computer (RISC) processor, an application specific integrated circuit (ASIC), a programmable logic device (PLD), a gate array, and/or any other circuit or processor capable of the functions described herein.

The memory 204, as described herein, is one or more devices that permit data, instructions, etc., to be stored therein and retrieved therefrom. The memory 204 may include one or more computer-readable storage media, such as, without limitation, dynamic random access memory (DRAM), static random access memory (SRAM), read only memory (ROM), erasable programmable read only memory (EPROM), solid state devices, flash drives, CD-ROMs, thumb drives, floppy disks, tapes, hard disks, and/or any other type of volatile or nonvolatile physical or tangible computer-readable media. The memory 204 may be configured to store, without limitation, a variety of data structures (including various types of data such as, for example, transaction data, LTVs associated with such transaction data, other variables, etc.) and/or other types of data (and/or data structures) suitable for use as described herein.

Furthermore, in various embodiments, computer-executable instructions may be stored in the memory 204 for execution by the processor 202 to cause the processor 202 to perform one or more of the functions described herein, such that the memory 204 is a physical, tangible, and non-transitory computer readable storage media. Such instructions often improve the efficiencies and/or performance of the processor 202 that is performing one or more of the various operations herein (e.g., one or more of the operations of method 300, etc.), whereby the computing device 200 may be transformed into a special-purpose computing device. It should be appreciated that the memory 204 may include a variety of different memories, each implemented in one or more of the functions or processes described herein.

In the exemplary embodiment, the computing device 200 includes a presentation unit 206 that is coupled to (and in communication with) the processor 202 (however, it should be appreciated that the computing device 200 could include output devices other than the presentation unit 206, etc. in other embodiments). The presentation unit 206 outputs information, either visually or audibly to a user of the computing device 200, such as, for example, warnings related to verification of LTVs, etc. Various interfaces (e.g., as defined by network-based applications, etc.) may be displayed at computing device 200, and in particular at presentation unit 206, to display such information. The presentation unit 206 may include, without limitation, a liquid crystal display (LCD), a light-emitting diode (LED) display, an organic LED (OLED) display, an “electronic ink” display, speakers, another computing device, etc. In some embodiments, presentation unit 206 may include multiple devices.

The computing device 200 also includes an input device 208 that receives inputs from the user (i.e., user inputs). The input device 208 is coupled to (and is in communication with) the processor 202 and may include, for example, a keyboard, a pointing device, a mouse, a touch sensitive panel (e.g., a touch pad or a touch screen, etc.), another computing device, and/or an audio input device. Further, in various exemplary embodiments, a touch screen, such as that included in a tablet, a smartphone, or similar device, may behave as both the presentation unit 206 and the input device 208.

In addition, the illustrated computing device 200 also includes a network interface 210 coupled to (and in communication with) the processor 202 and the memory 204. The network interface 210 may include, without limitation, a wired network adapter, a wireless network adapter, a mobile network adapter, or other device capable of communicating to one or more different networks, including the network 110. Further, in some exemplary embodiments, the computing device 200 may include the processor 202 and one or more network interfaces incorporated into or with the processor 202.

Referring again to FIG. 1, the system 100 includes a data quality check engine 114, which is specifically configured, by executable instructions, to perform one or more quality check operations on data, as described herein. As shown in FIG. 1, the engine 114 is illustrated generally as a standalone part of the system 100 but, as indicated by the dotted lines, may be incorporated with or associated with the payment network 106, as desired. Alternatively, in other embodiments, the engine 114 may be incorporated with other parts of the system 100 (e.g., the issuer 108, etc.). In general, the engine 114 may be implemented and/or located based on where, in path 112, for example, transaction data is stored, thereby providing access for the engine 114 to the transaction data, etc. In addition, the engine 114 may be implemented in the system 100 in a computing device consistent with computing device 200, or in other computing devices within the scope of the present disclosure. In various other embodiments, the engine 114 may be employed in systems at locations that allow for access to the transaction data, but that are uninvolved in the transaction(s) giving rise to the transaction data (e.g., at locations that are not involved in authorization, clearing, settlement, etc.).

The system 100 also includes data structure 116 associated with the engine 114. The data structure 116 includes a variety of different data (as indicated above), including transaction data and multiple LTVs. In the example system 100, the payment network 106 is configured to store the transaction data in the data structure 116 as generated during the course of transactions being performed to a plurality of payment accounts (e.g., in a production environment, etc.), consistent with the above, whereby the data structure includes transaction data for a plurality of payment accounts. The payment network 106 is then configured to generate the multiple LTVs, as stored in the data structure 116 (e.g., in an LTV table, etc.), based on the transaction data. In particular, the payment network 106 is configured to periodically generate multiple types of LTVs for each of the payment accounts at one or more intervals, such as, for example, a weekly interval, etc. (e.g., a lifetime spend LTV for each payment account; consumer electronics transaction velocity with a half-life of 180 days for each payment account; etc.).

With that said, in one or more other embodiments, the one or more of the LTVs may be general to a segment (or family) of payment accounts or be generated at one or more intervals. What's more, another entity (e.g., the issuer 108, etc.) may be configured to store part or all of the transaction data in the data structure 116 and/or generate part or all of the LTVs. In either case, the LTVs are often crucial to the success of the fraud model(s) generated by ML systems.

With continued reference to FIG. 1, Table 1 below illustrates an example LTV table of the data structure 116 in which the payment network 106 is configured to store LTVs in the example system 100.

TABLE 1

| PAN | LTV | LTV Value | Creation Date |
|---|---|---|---|
| xxxx-xxxx-xxxx-1234 | Lifetime_Spend | $25,124.34 | 03-18-20XX |
| xxxx-xxxx-xxxx-1234 | Lifetime_Spend | $23,509.12 | 03-11-20XX |
| xxxx-xxxx-xxxx-1234 | Tr_Vel_Cons_Elec_l80 | 25.1 | 03-18-20XX |
| xxxx-xxxx-xxxx-1234 | Tr_Vel_Cons_Elec_l80 | 24.9 | 03-11-20XX |
| xxxx-xxxx-xxxx-5678 | Lifetime_Spend | $10,050.58 | 03-18-20XX |
| xxxx-xxxx-xxxx-5678 | Lifetime_Spend | $9,145.26 | 03-11-20XX |
| xxxx-xxxx-xxxx-5678 | Tr_Vel_Cons_Elec_l80 | 12.9 | 03-18-20XX |
| xxxx-xxxx-xxxx-5678 | Tr_Vel_Cons_Elec_l80 | 12.8 | 03-11-20XX |
| . . . | . . . | . . . | . . . |

The LTV table (in Table 1) includes a plurality of payment accounts (as represented by a plurality of PANs (e.g., xxxx-xxxx-xxxx-1234, etc.) associated therewith), each associated with a plurality of types of LTVs (e.g., Lifetime_Spend representing the total lifetime spend to the associated payment account; Tr_Vel_Cons_Elec_180 representing consumer electronics transaction velocity with a half-life of 180 days for the associated payment account; etc.). Each LTV, then, is associated with a value and a creation date (e.g., two Lifetime_Spend LTVs are associated with the creation dates of March 18, 20XX and March 11, 20XX). The creation date represents the date on which the LTV value was generated per the interval (i.e., a weekly interval in example system 100). In this manner, the payment network 106 is configured to maintain LTVs for each payment account for the current (or latest) interval (e.g., March 18, 20XX), as well as each of the past (or prior/historical) intervals (e.g., March 11, 20XX).

In one or more other embodiments, the data structure 116 and/or the LTV table may be structure otherwise. For example, the number of past intervals for which LTV values are stored may be limited. Or, the payment network 106 may be configured to update the LTV values at each interval, rather than generating a new LTV at the interval. What's more, the LTV table may include entries general to a segment (or family) of payment accounts (e.g., silver cards, etc.), where the LTV table includes LTV values that are general to the segment of payment accounts (rather than being specific to a particular payment account).

With continued reference to FIG. 1, similar to the engine 114, the data structure 116 is illustrated as a standalone part of the system 100 (e.g., embodied in a computing device similar to computing device 200, etc.). However, in other embodiments, the data structure 116 may be included or integrated, in whole or in part, with the engine 114, as indicated by the dotted line therebetween. What's more, as indicated by the dotted circle in FIG. 1, the engine 114 and the data structure 116 may be included or integrated, in whole or in part, in the payment network 106.

With that said, the engine 114 is configured, in connection with performing a quality check of data in the data structure 116, to access the data structure 116 and, specifically, one or more of the LTVs described above and included in the data structure 116 and the underlying transaction data for the one or more of the LTVs (i.e., the transaction data that was used to generate each of the one or more LTVs). Once accessed, the engine 114 is configured, for each of the LTVs, to determine the value of the LTV (e.g., in an isolated environment outside of the production environment, etc.), to confirm an underlying source of data associated with the LTV, and to determine whether a change over time of the LTV is consistent with expectations.

In particular, and generally prior to the quality check, the payment network 106 is configured to determine various LTVs associated with the transaction data described above, and to store the LTVs in the data structure 116, as explained above. In the example system 100, the payment network 106 is configured to determine and store the LTVs in an LTV table consistent with Table 1 at weekly intervals (e.g., every Monday, etc.), as part of the payment network's production environment where transactions are processed, consistent with the above.

To the extent an issue, or error, is included in the processing of the transaction data, by the payment network 106, the resulting LTVs may be incorrect. As a quality check, then, the engine 114 is configured to access the underlying transaction data for the LTVs (i.e., the transaction data stored in the data structure 116 used to generate the LTVs) and to determine the values of the LTVs (e.g., each of the LTVs included in the LTV table in the data structure 116 for a plurality of payment accounts and a plurality of intervals (e.g., the current/most recent interval and prior intervals, etc.), etc.), independent of a process by which the LTVs were originally determined (e.g., as part of an isolated processes separate from the production environment, etc.). In this manner, the values of the LTVs are determined (or calculated) as check values. In one example, where an LTV represents total spend to a payment account (e.g., lifetime, yearly, monthly, weekly, or daily, etc.), the engine 114 may be configured to determine the LTV value (e.g., for the most recent/current total spend LTV and/or each prior total spend LTV, etc.) in an isolated environment by summing transaction amounts for each transaction to the payment account up to the associated creation date, for example, over the lifetime of the payment account or a shorter interval (e.g., a yearly interval, etc.). In another example, where an LTV represents total lifetime spend to multiple different payment accounts (e.g., each account belonging to a segment (or family) of payment accounts (e.g., platinum, gold, or silver cards, etc.), etc.), the engine 114 may be configured to determine the LTV value (e.g., for the most recent lifetime spend LTV, etc.) in an isolated environment by summing transaction amounts for each transaction to the multiple different accounts over the lifetime of the multiple different payment accounts up to the associated creation date.

In both examples, and in general, the engine 114, then, is configured to compare the LTV value determined in the isolated environment to the corresponding LTV value in the LTV table in the data structure 116. If the determined value of the LTV is the same as the value of the corresponding, originally generated LTV accessed in the data structure 116, the engine 114 is configured to determine that the LTV generated and stored in the LTV table of the data structure 116 (e.g., as part of the production environment, etc.) is accurate and/or confirmed.

It should be appreciated that in one or more embodiments, the engine 114 may be configured to access the underlying transaction data for LTVs for a random selection of payment accounts and to determine whether the LTVs for the random selection of payment accounts are accurate and/or confirmed, as part of the foregoing aspect of the LTV data value quality check. Further, in one or more embodiments, the engine 114 may be configured to make the random selection of the payment accounts from a particular region and/or segment (or family) of payment accounts (e.g., sliver payment accounts in New York, etc.), as part of the foregoing aspect of the LTV data value quality check. Or, the engine 114 may be configured to perform the foregoing aspect of the LTV data value quality check for one or more LTVs (e.g., all LTVs, etc.) for all payment accounts from a given region and/or segment (or family) of payment accounts. When generating/determining the values for the LTVs, the payment network 106 is configured to also capture transaction data specific to the LTVs, during which errors in the captured data may arise. For example, the payment network 106 may be configured to capture transaction data for all silver payment accounts in New York. In connection therewith, errors in the captured data may arise, for example, based on one or more coding errors in the data extractions, the transform and loading processes, or based on accounts being assigned to incorrect families and/or segments, etc. However, the engine 114 is configured to determine which PANs for the payment accounts are associated with the particular LTVs (e.g., the LTVs subject to the LTV data value quality check above, etc.) based, for example, on the LTV table in the data structure 116. For the PANs determined to be associated with the particular LTVs, the engine 114 is then configured to determine a count of the number of different PANs associated with the particular LTVs and, thus, the number of different payment accounts associated with the particular LTVs.

The engine 114 is also configured to access an expected count of PANs and/or payment accounts. For example, where the engine 114 is configured to determine whether the LTV values for an LTV representing an annualized value of spend for silver payment accounts in New York is accurate and/or confirmed, the engine 114 is configured to access an expected count of PANs and/or payment accounts for sliver payment accounts in New York. In any case, the engine 114 is configured to compare the expected count and the determined count. Based on the comparison indicating a mismatch of the expected count and the determined count, the engine 114 is configured to detect a count error. Alternatively, based on the comparison indicating a match, the engine 114 is configured to detect a count consistency.

In addition in the system 100, in connection with performing the quality check, the engine 114 is configured, for each of the LTVs (e.g., each LTV subject to the LTV data value quality check above and/or the count check above, etc.), to calculate one or more moments for the given period. For example, the engine 114 may be configured to calculate a first moment and a second moment for the LTV (e.g., a moment pair, etc.). In particular, in this exemplary embodiment, the engine 114 is configured to employ Equation (1) in connection with calculating both the first moment and the second moment.

$${M}_{t , p} = \frac{1}{N} {\sum }_{N} {X}_{t}^{p} \qquad ( 1 )$$

In Equation (1), Xₜ are data points (i.e., LTV values) observed at time t (e.g., the current interval or a prior interval, etc.); N is the number of data points in a sample set (e.g., the number of values for the LTV created in the LTV table of the data structure 116 across the current interval and each prior interval (e.g., for the Lifetime_Spend LTV, etc.), etc.), and M_{t,p} is the p-th moment at time t.

In this exemplary embodiment, the first moment is calculated as a mean of all the values for the LTV (e.g., the Lifetime_Spend LTV in the LTV table of the data structure 116, etc.), and the second moment is calculated as a mean of the squared values. Then, after calculating the first and second moments, the engine 114 is configured to calculate the LTV over different weeks, as week-over-week (WOW) percentage changes, based on Equation (2).

$$WOW {\%}_{t} = \frac{{M}_{t , p} - {M}_{t - 1 , p}}{{M}_{t - 1 , p}} \qquad ( 2 )$$

With that said, it should be appreciated that the engine 114 may be configured to calculate one or more different metrics, other than moments or WOW percentage changes, for example, associated with the LTVs in other exemplary embodiments. The above metrics and other potential metrics, then, may be based on the same interval above (i.e., a week and/or 52 weeks) or other intervals, as appropriate.

Next in the system 100, the engine 114 is configured to generate an anomaly detection model (e.g., a binary classifier, etc.) based on prior transaction data, and in particular, in this embodiment, based on the last year of transaction data for the given LTV (i.e., a least 52 weeks of WOW percentage changes of the given LTV (e.g., the Lifetime_Spend LTV values associated with the creation dates prior to the most recent creation date (e.g., the prior intervals, etc.), etc.)) (broadly, an interval-over-interval (IOI)). In so doing, the engine 114 is configured to generate the anomaly detection model based on an isolation forest algorithm (or analysis). In connection therewith, the engine 114 is configured to rely on certain model parameters, as designated by a user associated with the engine 114 and/or the model. In the above example regarding the silver payment accounts in New York, the parameters may include 100 estimators (i.e., potential questions/decisions to generate the model, etc.), 2 features to train each base estimator (e.g., the first and second moments, etc.), and a 10% contamination (e.g., a proportion of outliers in the data, etc.). It should be appreciated that these parameters may be otherwise in other embodiments and/or other model implementations.

What's more, in this exemplary embodiment, the engine 114 is configured to generate the model based on weighted features, whereby the first moment and the second moment are weighted differently (i.e., not evenly). For instance, the engine 114 may be configured to apply a weight of 66% to the WOW percentage change for the first moment and a weight of 33% for the WOW percentage change for the second moment. It should be appreciated that the engine 114 may be configured to employ other, different weightings of the features (or different features, or different numbers of features, etc.), or no weighting, in other system embodiments. In addition, while the above describes generation of the model after the calculation of the WOW percentage(s) (or other IOI percentage(s)) for the last LTV, it should be appreciated that the isolation forest model may be generated prior to calculating the moments for the last LTV, or percentage changes associated therewith, etc.

The generated model will also include parameters and a threshold (e.g., based on the contamination, etc.), for use by the engine 114. Thereafter, the engine 114 is configured to apply the model to the latest data for the LTV (e.g., the LTV associated with the most recent creation date (i.e., the current interval), etc.), and in particular, the WOW percentage change of the first and second moments of the latest data for the LTV. The model, when applied, will determine if the latest data for the LTV is an outlier, or not.

In this exemplary embodiment, the engine 114 is configured to then apply one or more business rules to the determination, which may reclassify an outlier as not an outlier. Specifically, for example, when an outlier for total spend for a type of payment account is determined, by the model, in late November, a business rule may be employed to outset or undo the designation of outlier based on the increased shopping associated with the day after Thanksgiving, i.e., the so-called Black Friday. It should be appreciated that various other business rules may be applied, after the model, to inhibit false positive outliers from being indicated to one or more users associated with the model. For example, a business rule may be imposed for the WOW % thresholds (e.g., raise or lower, etc.), for retail, flower shops, and e-commerce on Black Friday, Cyber Monday and/or Valentine's Day, whereby the result of the classifier may be ignored and/or reclassified.

Finally, when a latest set of transaction data for an LTV is determined to be an outlier (or an anomaly), the engine 114 is configured to generate a flag for the specific LTV, for manual review by one or more users associated with the data and/or a service upon which the data relies (e.g., a fraud analyst, etc.). Otherwise, the engine 114 is configured to move on to the next LTV included in a schedule for data quality checking. In one or more embodiments, the engine 114 may also (or alternatively) be configured to generate a flag for the specific LTV when a prior set of transaction data for the LTV is determined to be an outlier (or an anomaly), for manual review by one or more users associated with the data and/or a service upon which the data relies.

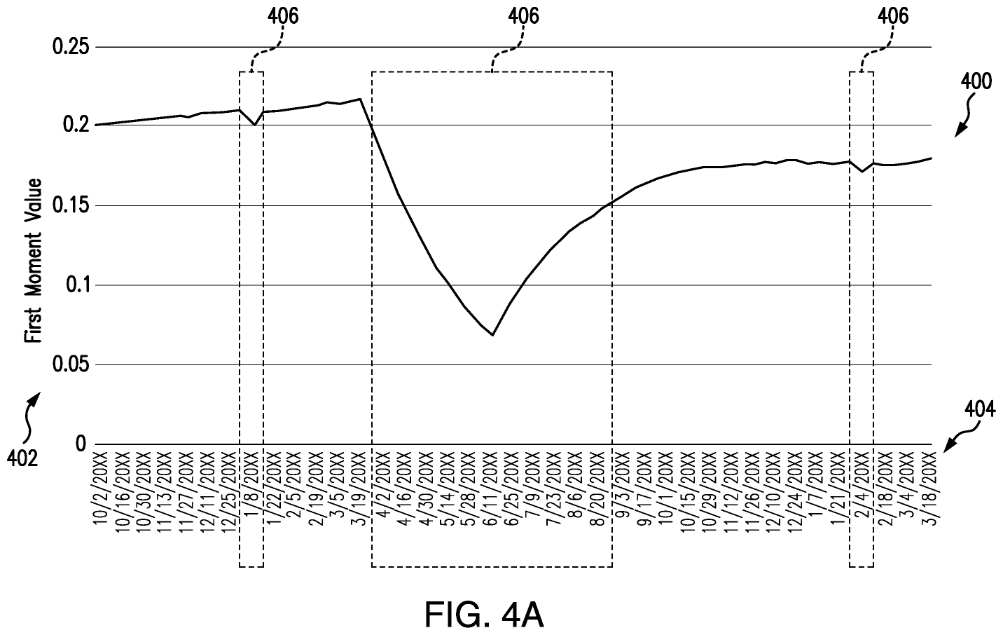

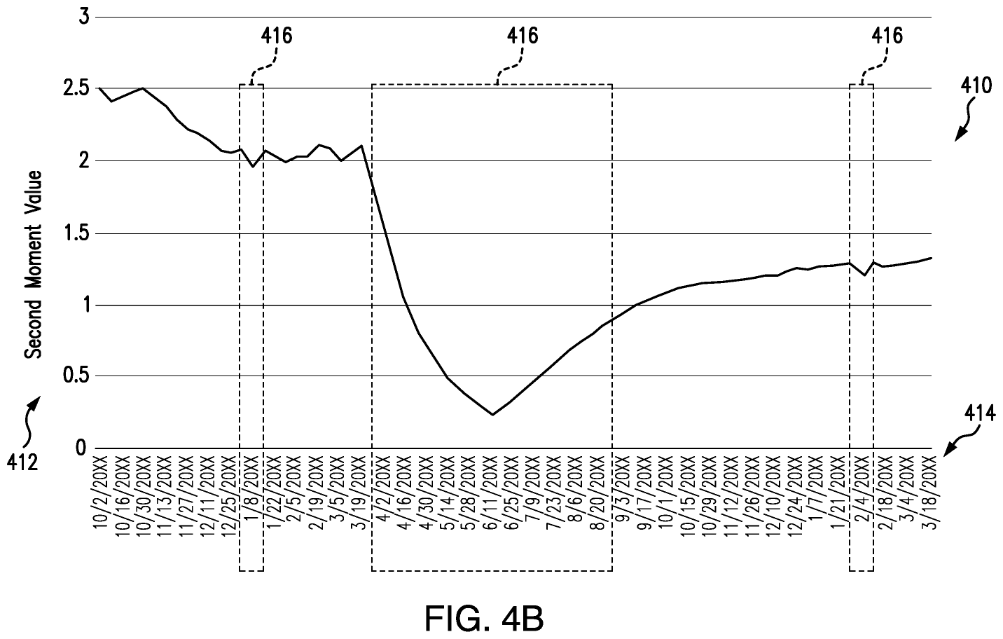

In connection with the above, FIGS. 4A and 4B illustrate a time series 400 of a first moment and a time series 410 of a second moment, respectively, in accordance with Equation (1) for a given LTV. The y-axes 402, 412 for each of the series 400, 410 represents the moment value at a given date along the x-axes 404, 414. As can be appreciated, a visual analysis of the data associated with each of the time series 400, 410 indicates significant outliers or anomalies at the dates of January 8, 20XX and April 2, 20XX through August 20, 20XX for a given year, and February 4, 20XX for the following year, as highlighted by the rectangular, dashed indicator boxes 406, 416.

However, based on the above disclosure, users are relieved from having to manually plot and isolate outliers/deviations. In particular, the engine 114 is configured to generate an interface (e.g., a graphical user interface (GUI), etc.) flagging each value for a particular LTV over a current interval and prior intervals as either an outlier (or anomaly) or an inlier (or normal). The engine 114 is then configured to transmit the interface to one or more users.

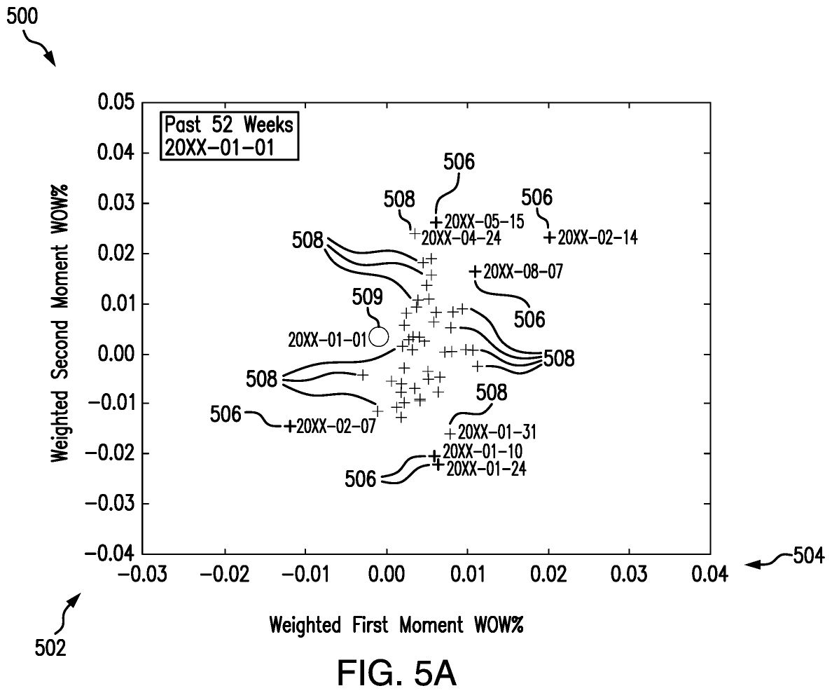

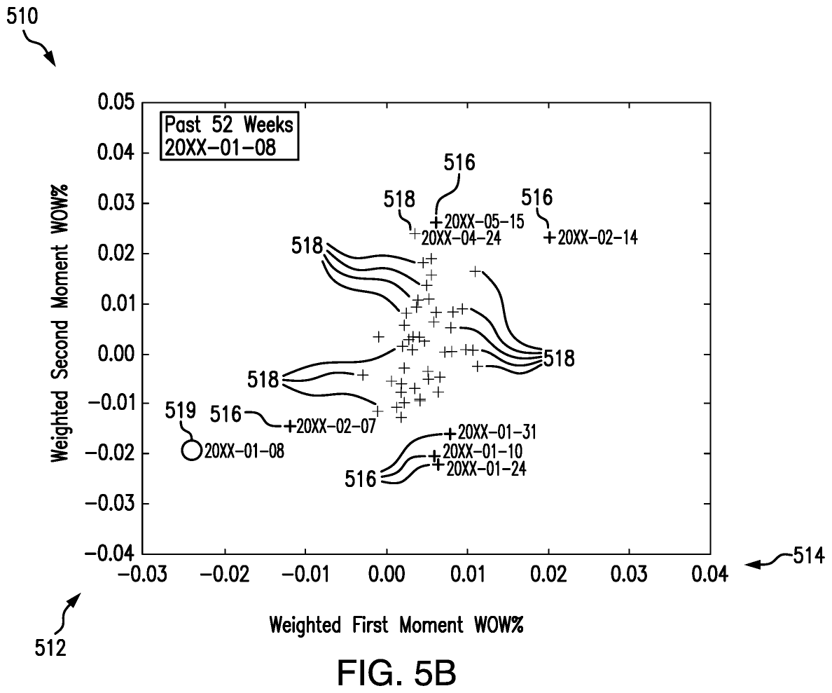

FIGS. 5A and 5B illustrate example interfaces 500, 510 generated and transmitted by the engine 114. In FIGS. 5A and 5B, the interfaces 500, 510 present the results produced by the engine 114 and include scatter plots for the weighted first moment WOW percentage along the x-axes 504, 514 and weighted second moment WOW percentage along the y-axes 502, 512. Specifically, the interfaces 500, 510 display alerts (or flags) for time periods and, in particular, prior intervals and/or current intervals for which anomalous values (as well as normal inlier values) for the given LTV were detected.

In connection therewith, interface 500 of FIG. 5A displays alerts for a current January 1, 20XX interval and 52 week intervals prior to January 1, 20XX. And, interface 510 of FIG. 5B displays alerts for a current January 8, 20XX interval and 52 week intervals prior to January 18, 20XX. In both interfaces 500, 510, the cross marks 506, 516 (emphasized in a bold style in the figures) alert to detected anomalies for the value for the given LTV created on the referenced prior interval. For example, in FIG. 5A, the cross marks 506 alert to the detection of values for the given LTV created for the January 10, 20XX, January 24, 20XX, February, 7, 20XX, February 14, 20XX, May 15, 20XX, and August 7, 20XX weekly intervals (for the year prior to the current January 1, 20XX interval) as anomalies. Then, on both interfaces 500, 510, the cross marks 508, 518 (illustrated in normal style in the figures) alert to the detection of values as normal inliers. For example, in FIG. 5A, the cross marks 508 alert to the detection of values for the given LTV created on April 24, 20XX and January 31, 20XX (again, for the year prior to the current January 1, 20XX interval), among others, as normal inliers. The same is true for interface 510 of FIG. 5B. However, in the interface 500 of FIG. 5A, the circle 509 (which may be illustrated in a normal style) alerts to the detection of the values for the given LTV created for the current weekly January 1, 20XX as a normal inlier. Yet, in the interface 510 of FIG. 5B, the circle 519 (which may be emphasized in a bold style or colored style, etc.) alerts to the detection of the value for the given LTV created for the current weekly January 8, 20XX interval as an anomaly.

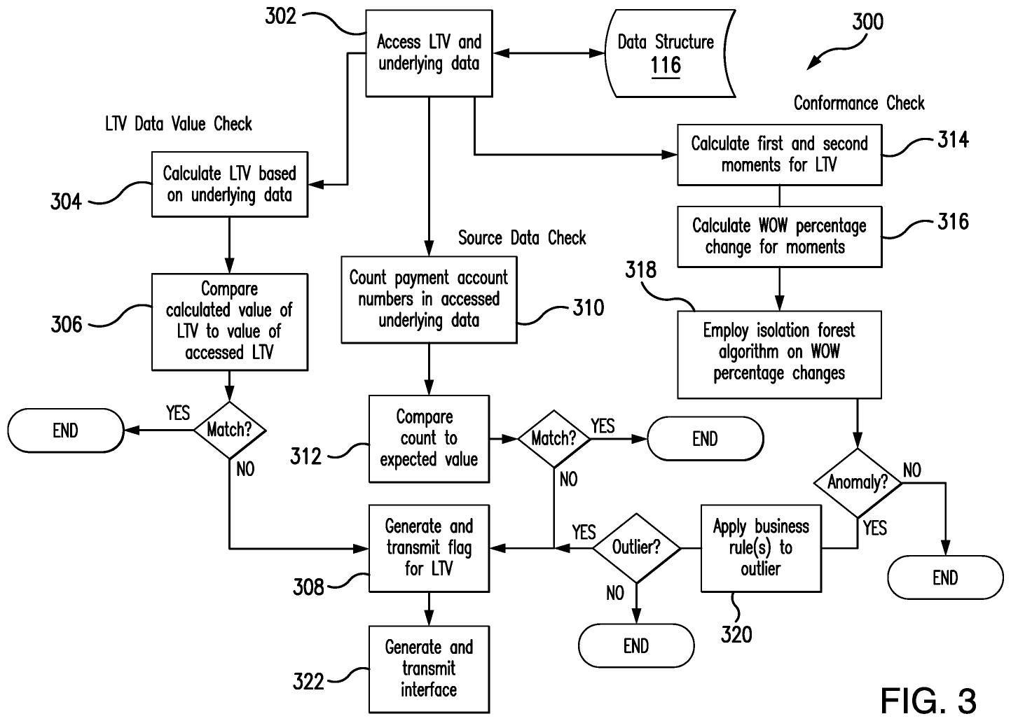

FIG. 3 illustrates an exemplary method 300 for performing data quality checks on data stored in data structures. The exemplary method 300 is described as implemented in the engine 114. However, it should be understood that the method 300 is not limited to the above-described configuration of the engine 114, and that the method 300 may be implemented in other ones of the computing devices 200 in system 100, or in multiple other computing devices. As such, the methods herein should not be understood to be limited to the exemplary system 100 or the exemplary computing device 200, and likewise, the systems and the computing devices herein should not be understood to be limited to the exemplary method 300.

In the method 300, the data structure 116 includes multiple different LTVs generated by the payment network 106 (for one or more purposes) (e.g., in an LTV table consistent with Table 1 above, etc.), and also includes underlying transaction data upon which the LTVs are generated by the payment network 106. One such LTV includes a count of all payment transactions to the merchant 102 in the state of Missouri and involving platinum payment accounts issued by the issuer 108. Such LTV may be relied upon, for example, in fraud detection and/or prevention tools implemented by the payment network 106, etc. As such, it is important for the LTV, and the underlying transaction data, to be accurate for the fraud detection and/or prevention tools to be effective. That said, it should be appreciated that other data structures (related to transaction data or not) may be subject to the methods herein to yield similar or comparable efficiencies, accuracies, and/or improvements in quality checking data.

As shown in FIG. 3, initially in the method 300, the engine 114 accesses, at 302, from the data structure 116, the value for the latest LTV relating to the count of transactions to merchant 102 in Missouri involving platinum payment accounts issued by the issuer 108, and also the underlying transaction data used for the LTV count (e.g., all transactions to merchant 102, involving a platinum payment account and taking place in Missouri; etc.) (e.g., authorization records for the transactions including payment account numbers, merchant names, merchant IDs, transaction amounts, etc.). In addition, the engine 114 also accesses, at 302, prior values for the LTV count over a defined interval (e.g., the last 52 weeks, etc.). It should be appreciated that such accessing operation, at 302, may include accessing the underlying transaction data in whole, or in part, depending, for example, on the type of the LTV generated from the data, etc. For example, the engine 114 may access only the underlying data necessary to re-calculate the LTV, or it may access additional data as described below.

After accessing the LTV count and the corresponding transaction data, the engine 114 next imposes/performs one or more LTV checks thereon. In the method 300, the engine 114 performs three separate quality checks on the data for the LTV: (1) an LTV data value check, (2) a source data check, and (3) a conformance check of the data for the LTV (as compared to prior data for the LTV). It should be understood that each check may be performed sequentially, in any order, or in parallel, as desired. What's more, two checks may be completed in parallel, and the third check completed after, or vice-versa.

In connection therewith, for the LTV data value check, the engine 114 calculates, at 304, the LTV value based on the underlying transaction data (e.g., in an isolated environment separate from the production environment in which the LTV value was originally generated, etc.). For instance, in a production environment, underlying transaction data for the LTV may be accessed improperly, or an algorithm used for calculating the LTV may be incorrect or errant, etc., whereby the LTV is improperly generated in the production environment, even though the data available to the payment network 106 for the calculation of the LTV is accurate. This may be caused, for example, by errant computer logic (either when written or implemented), unknown bugs in software libraries, etc. Then, after calculating the LTV, the engine 114 compares, at 306, the calculated value of the LTV to the original value of the LTV accessed in the data structure 116 (and as generated in the production environment). If the values match, the engine 114 ends the LTV data value check portion of the quality check (as being successful). Conversely, if the values do not match, the engine 114 generates, at 308, a flag for the LTV. And, the flag is also transmitted, at 308, to a user associated with the LTV, as a request for manual validation and/or investigation of the LTV. The flag may indicate the specific name of the LTV and the nature of the quality check that failed (e.g., “Grocery store transaction velocity with half-life of 180 days—LTV data value mismatch,” etc.).

For the source data check, the engine 114 counts, at 310, the number of distinct payment account numbers included in the underlying transaction data associated with the payment accounts for which the LTV was confirmed and/or flagged as part of the LTV data value check at 304, 306, and/or 308. The engine 114 then compares, at 312, the count to a count of known active PANs (e.g., for platinum accounts issued by the issuer 108 that have initiated transactions with merchant 102 in Missouri in the last 52 weeks, etc.), a time series analysis of historical PAN counts (e.g., taking into account that certain deviations in active PAN counts may trigger flags, etc.) (e.g., through clustering, etc.), and/or other analysis of historical PAN counts (e.g., as compared to prior known data points, etc.). If the values match, the engine 114 ends the source data check portion of the quality check. Conversely, if the values do not match, the engine 114 generates, at 308, a flag for the LTV. And, the flag is also transmitted, at 308, to a user associated with the LTV, as a request for manual validation and/or investigation of the LTV. The flag may, again, indicate the specific name of the LTV and the nature of the quality check that failed (e.g. “Department store transaction velocity with half-life of 360 days—source data failure,” etc.).

With continued reference to FIG. 3, for the conformance check, the engine 114, in general, calculates a value representative of a distribution of the count of transactions, as described above, over a defined interval (i.e., historical values for the LTV, or historical LTVs for the given count parameter). The defined interval may include a prior one week, four weeks, 12 weeks, 26 weeks, 52 weeks, or some other desired interval. In addition, the distribution of the count of transactions may be represented in a variety of different manners.

In particular in the method 300, the engine 114 calculates, at 314, values for a first moment and a second moment of the LTV (e.g., a moment pair for the specific value of the LTV, etc.). The moment pair, in this example, is calculated for each LTV over the defined interval. In so doing, the engine 114 accesses, at 302, each of the calculated values for the LTV (as originally calculated by the payment network 106, for example) for each of the last 52 weeks and calculates, at 314, as the first moment, a mean for the count of the transactions. Then, for each LTV value over the last 52 weeks, the engine 114 calculates, at 314, a mean of the LTV values raised to the second power (i.e., squared) as the second moment. In so doing, each of the first and second moments is calculated, by the engine 114, through use of Equation (1) above.

When the first and second moments, or moment pair, are calculated, the engine 114 next accesses the moments for the prior LTV values (e.g., for the last 52 weeks in the above example, etc.), in the data structure 116 (or, potentially, the engine 114 also calculates the moment pairs for the last 52 weeks). The engine 114 then calculates, at 316, a WOW percentage change for the moment pairs. The WOW percentage change provides an indication of the change in the LTV over the limited time interval, i.e., each week. It should be appreciated that the moment pairs may be used directly, or a different representation or derivation of the moment pairs may be employed in other method embodiments.

With the WOW percentage changes, for each of the last 52 weeks (in this example), the engine 114 then employs an isolation forest algorithm on the WOW percentage changes, at 318. In so doing, an anomaly detection model for the last 52-weeks of data (or other interval) for the LTV (i.e., for the WOW percentage changes) is generated. Specifically, in this embodiment, the engine 114 generates a model based on an isolation forest algorithm, in which certain parameters of the algorithm are set based on input from a user (e.g., a data integrity analyst, etc.). For example, a number of estimators is selected, which is a number of individual decisions decided to get to an output of the model. In the current example, the number of estimators is selected to be 100, which requires the model to generalize the decision sufficiently so as not to reproduce the training data set (i.e., the 52 weeks of WOW percentage changes). It should be appreciated that a different number of estimators may be used in other embodiments, depending on, for example, the predictability of the LTV, type of LTV, etc. In addition, a feature parameter is set to 2 in connection with the model, in this embodiment, to account for the first and second moments (i.e., the inputs of the model). Again, a different number of features may be included and/or provided for in the model in other embodiments, for example, based on how the distribution of the LTV, over time, is represented. In one example, a third moment may be determined for the LTV, whereby the model would include and/or provide for three features (rather than two).

Further, as to generating the model, a contamination of 10% is permitted, whereby the percentage is reduced to a threshold in the model, to distinguish, in this embodiment, between inliers (or expected LTV data values) and outliers. The contamination may again be different in other embodiments, for a variety of reasons. In general, as used in this example, the contamination is a proxy for the sensitivity of the model to deviations.

Then, based on the above, the engine 114 generates the anomaly detection model. And, the engine 114 applies the model to the latest LTV data, or more specifically, the WOW percentage change of the moment pair of the latest LTV data.

By application of the anomaly detection model, the engine 114 determines whether the latest LTV data is an inlier or outlier (according to the model) (i.e., the engine 114 determines if an anomaly exists). When the latest LTV data is an inlier, the engine 114 exits the conformation check and/or advances to the next LTV in the scheduled to be checked (or to a next check of the instant LTV). In one or more embodiments, the engine 114 may also determine whether the prior LTV data includes inliers or outliers (according to the model).

When the latest LTV data is determined to be an outlier, the engine 114 applies one or more business rules, at 320, to the outlier. When a WOW percentage change, or other metric of an LTV, changes more than expected, such that it is an outlier, business reasons may exist for the deviations. For example, holiday shopping may be a business reason for total spend LTVs to deviate from a total spend expectancy for a given time period (which is based, at least in part, on non-holiday spending). As such, the engine 114 accesses and applies one or more business rules, which, in general, de-designate the latest LTV data from being an outlier when the one or more rules are satisfied. After the one or more business rules are applied, the engine proceeds either with the latest LTV data designed as an outlier, or not.

When the latest LTV data is still an outlier or anomaly, the engine 114, as above, generates, at 308, a flag for the LTV value. The flag may indicate the specific name of the LTV (e.g., by name or other designation, etc.) and a reason for the flag (e.g. “Total Spend in New York, N.Y.—conformance check failure,” etc.).

When all three of the quality checks are complete, by the engine 114, and no flags are generated, the engine 114 exits and/or advances to the next LTV in the schedule to be checked (or to a next one of the quality checks of the instant LTV). As such, the engine 114 may continue to perform quality checks on multiple different LTVs according to one or more schedules, which may include one or more different regular intervals (e.g., monthly, weekly, daily, etc.), or irregular intervals. In connection therewith, the engine 114 is tuned to ensure proper quality checks for data, and thus, the quality of later processes relying on the LTV values generated by the payment network 106 and/or included in the data structure 116.

The engine 114 further notifies one or more users associated with the LTV(s) of the flag(s), for example, by transmitting a notice (e.g., an electronic mail message, etc.) to the one or more users. Upon receipt thereof, the one or more users may proceed to investigate and/or analyze the specific LTV, process, and/or payment account which has been flagged. What's more, in connection with notifying a user, the engine 114 may generate and transmit, at 322, an interface (e.g., a graphical user interface (GUI), etc.) identifying each flagged value for each LTV identified as an outlier or anomaly, consistent with the above explanation of interfaces 500, 510. Further, in one or more embodiments, the interfaces 500, 510 may be considered the flag(s).

In view of the above, the systems and methods herein provide for improved data quality checks for long term variables (LTVs). The disclosure is demonstrably effective at alerting users of data quality incidences in LTVs (e.g., as inputs to machine learning systems, etc.), is scalable for production environments in which several, hundreds, or thousands, or more, etc. of LTVs are generated, and/or is adept at providing alerts usable in debugging the data quality incidents. The systems and methods herein leverage the LTVs' generally stable nature over time to provide for such quality checks.

Again and as previously described, it should be appreciated that the functions described herein, in some embodiments, may be described in computer executable instructions stored on a computer readable media, and executable by one or more processors. The computer readable media is a non-transitory computer readable storage medium. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one of the following operations: (a) accessing, by a computing device, from a data structure, a value of a long term variable (LTV), transaction data underlying the value of the LTV, and multiple historical values of the LTV, wherein each LTV value is specific to one of multiple payment accounts; (b) calculating, by the computing device, a check value of the LTV, based on the transaction data underlying the value of the LTV; (c) calculating, by the computing device, a first moment associated with the LTV, for each of the multiple payment accounts, based on the value of the LTV and the historical values of the LTV over a defined interval; (d) calculating, by the computing device, a second moment associated with the LTV, for each of the multiple payment accounts, based on the value of the LTV and the historical values of the LTV over the defined interval, wherein the first moment and the second moment provide a moment pair for the payment account; (e) performing, by the computing device, an isolation forest analysis based on the moment pairs; and (f) generating, by the computing device, a flag for the LTV, when the check value is different than the value of the LTV, and/or when the isolation forest analysis indicates the calculated moment pair is an anomaly, thereby directing a manual review of the value of the LTV.

Exemplary embodiments are provided so that this disclosure will be thorough, and will fully convey the scope to those who are skilled in the art. Numerous specific details are set forth, such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail.

The terminology used herein is for the purpose of describing particular exemplary embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” and the phrase “at least one of” includes any and all combinations of one or more of the associated listed items.

In addition, as used herein, the term product may include a good and/or a service.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

None of the elements recited in the claims are intended to be a means-plus-function element within the meaning of 35 U.S.C. § 112(f) unless an element is expressly recited using the phrase “means for,” or in the case of a method claim using the phrases “operation for” or “step for.”

The foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for use in performing data quality checks on input variables to machine learning systems, the method comprising:
accessing for multiple payment accounts, by a computing device, from a data structure, a value of a long term variable (LTV), transaction data underlying the value of the LTV, and multiple historical values of the LTV, wherein the value of the LTV and the historical values of the LTV are specific to the multiple payment accounts;
calculating, by the computing device, a check value of the LTV, based on the transaction data underlying the value of the LTV;
calculating, by the computing device, a first moment associated with the LTV, for each of the multiple payment accounts, based on the value of the LTV and the historical values of the LTV over a defined interval;
calculating, by the computing device, a second moment associated with the LTV, for each of the multiple payment accounts, based on the value of the LTV and the historical values of the LTV over the defined interval, wherein the first moment and the second moment provide a moment pair for the payment account;
performing, by the computing device, an isolation forest analysis based on the moment pair for each of the multiple payment accounts; and
generating, by the computing device, a flag for the LTV, when the check value is different than the value of the LTV and/or when the isolation forest analysis indicates the calculated moment pair, for at least one of the multiple payment accounts, is an anomaly, thereby directing a manual review of the value of the LTV.

2. The computer-implemented method of claim 1, wherein calculating the first moment includes calculating a mean of the value of the LTV and the historical values of the LTV.

3. The computer-implemented method of claim 2, wherein calculating the second moment of the LTV includes calculating the mean of a squared value of the LTV and squared historical values of the LTV.

4. The computer-implemented method of claim 1, further comprising:
calculating an interval-over-interval (MI) percentage change of the LTV, for each of the multiple payment accounts, based on the calculated first moment and historical first moments for the LTV, over the defined interval;
calculating an IOI percentage change of the LTV, for each of the multiple payment accounts, based on the calculated second moment and historical second moments for the LTV, over the defined interval, the IOI percentage change of the first moment and the IOI percentage change of the second moment defining an IOI percentage change pair; and
wherein performing the isolation forest analysis based on the moment pair for each of the multiple payment accounts includes applying the isolation forest analysis to the IOI percentage change pair for the corresponding payment account.

5. The computer-implemented method of claim 4, wherein the IOI percentage change includes a week-over-week (WOW) percentage change.

6. The computer-implemented method of claim 5, wherein the WOW percentage change is calculated based on the following:
$$WOW {\%}_{t} = \frac{{M}_{t , p} - {M}_{t - 1 , p}}{{M}_{t - 1 , p}} .$$

7. The computer-implemented method of claim 1, wherein the LTV includes a transaction count within a geographic region.

8. The computer-implemented method of claim 1, further comprising counting a number of payment accounts included in the data underlying the value of the LTV; and
generating a flag for the LTV when the count of the number of payment accounts is different than an expected count.

9. The computer-implemented method of claim 8, wherein the LTV is associated with a type of payment account; and
wherein counting the number of payment accounts includes counting the number of payment accounts consistent with the type of payment account.

10. A system for use in performing data quality checks, the system comprising:
a memory including a data structure, the data structure including a long term variable (LTV), transaction data underlying the value of the LTV, and multiple historical values of the LTV; and
at least one processor in communication with the memory, the at least one processor configured to:
access, from the data structure, a value of the LTV, the transaction data underlying the value of the LTV, and the multiple historical values of the LTV;
calculate a check value of the LTV, based on the transaction data underlying the value of the LTV;
calculate a first moment associated with the LTV based on the value of the LTV and the historical values of the LTV over a defined interval;
calculate a second moment associated with the LTV, based on the value of the LTV and the historical values of the LTV over the defined interval, wherein the first moment and the second moment provide a moment pair;
perform an isolation forest analysis based on the moment pair; and
generate a flag for the LTV when the isolation forest analysis indicates the calculated moment pair is an anomaly.

11. The system of claim 10, wherein the at least one processor is configured to, in connection with calculating the first moment, calculate a mean of the value of the LTV and the historical values of the LTV; and
wherein the at least one processor is configured to, in connection with calculating the second moment, calculate the mean of a squared value of the LTV and squared historical values of the LTV.

12. The system of claim 10, wherein the at least one processor is further configured to:
calculate an interval-over-interval (IOI) percentage change of the LTV, based on the calculated first moment and historical first moments for the LTV, over the defined interval;
calculate an IOI percentage change of the LTV based on the calculated second moment and historical second moments for the LTV, over the defined interval, the IOI percentage change of the first moment and the IOI percentage change of the second moment defining an IOI percentage change pair; and
in connection with performing the isolation forest, apply the isolation forest to the IOI percentage change pair.

13. The system of claim 10, wherein the LTV includes a transaction count within a geographic region for a particular type of payment account.

14. The system of claim 13, wherein the IOI percentage change includes a week-over-week (WOW) percentage change of the transaction count.

15. The system of claim 14, wherein the at least one processor is configured to calculate the WOW percentage change based on the following:
$$WOW {\%}_{t} = \frac{{M}_{t , p} - {M}_{t - 1 , p}}{{M}_{t - 1 , p}} ,$$
where M_{t,p} is the p-th moment at time t.

16. The system of claim 10, wherein the at least one processor is further configured to:
count a number of payment accounts included in the transaction data underlying the value of the LTV; and
generate a flag for the LTV when the count of the number of payment accounts is different than an expected count.

17. A non-transitory computer readable storage medium including executable instructions for use in performing data quality checks on transaction data stored in data structures, which when executed by at least one processor, cause the at least one processor to:
access, from a data structure, a value of a long term variable (LTV), transaction data underlying the value of the LTV, and multiple historical values of the LTV;
calculate a check value of the LTV, based on the transaction data underlying the value of the LTV;
calculate a first moment associated with the LTV, based on the value of the LTV and the historical values of the LTV over a defined interval;
calculate a second moment associated with the LTV, based on the value of the LTV and the historical values of the LTV over the defined interval, wherein the first moment and the second moment provide a moment pair;
perform an isolation forest analysis based on the moment pair; and
generate a flag for the LTV, when the check value is different than the value of the LTV, and/or when the isolation forest analysis indicates the calculated moment pair is an anomaly.

18. The non-transitory computer readable storage medium of claim 17, wherein the instructions, when executed by the at least one processor, cause the at least one processor to:
in connection with calculating the first moment, calculate a mean of the value of the LTV and the historical values of the LTV; and
in connection with calculating the second moment, calculate a mean of a squared value of the LTV and squared historical values of the LTV.

19. The non-transitory computer readable storage medium of claim 18, wherein the instructions, when executed by the at least one processor, further cause the at least one processor to:
calculate an interval-over-interval (IOI) percentage change of the LTV, based on the calculated first moment and the historical first moments for the LTV, over the defined interval;
calculate an IOI percentage change of the LTV based on the calculated second moment and the historical second moments for the LTV, over the defined interval, wherein the IOI percentage change of the first moment and the IOI percentage change of the second moment define an IOI percentage change pair; and
in connection with performing the isolation forest analysis, apply the isolation forest to the IOI percentage change pair.

20. The non-transitory computer readable storage medium of claim 19, wherein the IOI percentage change includes a week-over-week (WOW) percentage change; and
wherein the WOW percentage change is calculated based on the following:
$$WOW {\%}_{t} = \frac{{M}_{t , p} - {M}_{t - 1 , p}}{{M}_{t - 1 , p}} ,$$
where M_{t,p} is the p-th moment at time t.
